(19) United States
(12) Patent Application Publication
(10) Pub. No.: US 2005/0032005 A1
(43) Pub. Date: Feb. 10, 2005

(54) Colour photographic silver halide material

(75) Inventors: Peter Bell, Koln (DE); Thomas Stetzer, Langenfeld (DE); Klaus Wagner, Bergisch-Gladbach (DE)

Correspondence Address: CONNOLLY BOVE LODGE & HUTZ, LLP, P O BOX 2207, WILMINGTON, DE, 19899, US

(73) Assignee: Agfa-Gevaert N.V., Mortsel (BE)

(21) Appl. No.: 10/897,510

(22) Filed: Jul. 23, 2004

(30) Foreign Application Priority Data
Aug. 5, 2003 (DE) DE 103 35 728.9

(51) Int. Cl. G03C 7/00

(52) U.S. Cl. 430/357; 430/365

(57) ABSTRACT

A colour photographic recording material having a support, at least two blue-sensitive, yellow coupler-containing silver halide emulsion layers of differing photographic sensitivity, at least two green-sensitive, magenta coupler-containing silver halide emulsion layers of differing photographic sensitivity and at least two red-sensitive, cyan coupler-containing silver halide emulsion layers of differing photographic sensitivity, characterised in that the silver application rate is less than 3.2 g of silver per m², camera sensitivity is at least ISO 100 and wherein, when an exposure is made of a grey card of density 0.6 with fluorescent light of light colour 21, the recording material gives rise to a hue on the print which, in CIELab values, meets the conditions a>0 and 0<b<30, if the photograph exposed with daylight is at a=b=0 with the same print filter pack, is distinguished by improved colour reproduction and in particular by a reduced green cast on exposure with fluorescent light.

The invention relates to a colour photographic recording material having a support, at least two blue-sensitive, yellow coupler-containing silver halide emulsion layers of differing photographic sensitivity, at least two green-sensitive, magenta coupler-containing silver halide emulsion layers of differing photographic sensitivity and at least two red-sensitive, cyan coupler-containing silver halide emulsion layers of differing photographic sensitivity.

It is known, for example from RD 38957, 1996, page 591, X.C., that the colour reproduction of colour photographic silver halide materials can be enhanced with DIR couplers. This substantially also applies when it is a matter of optimising colour reproduction under illumination conditions other than moderate sunlight. Such illumination means often do not have a continuous emission spectrum like sunlight, but instead a band spectrum which suggests daylight to the human eye. Typical examples of such lamps are fluorescent lamps which exhibit emission bands in the green range of the spectrum. If the subject is illuminated with such light sources, a green cast is obtained which, in the presence of a mixed light from daylight/fluorescent lamp light sources, often cannot be filtered out. It is possible, as has been realised in Fuji's Reala film, to eliminate this problem by means of a fourth layer in the green-sensitive package, which layer is cyan-sensitised and has an inhibitory action on the red-sensitive package. An increased quantity of silver is, however, required for this purpose.

It is known from DE 25 09 722 to associate two different DIR compounds, which must differ by a factor of at least 1.5 with regard to their reactivity, with a silver halide emulsion layer. By means of, this measure, it is straightforward to adjust the gradation curve without requiring a large number of DIR compounds. The advantages are demonstrated on a cyan layer and the material used had a silver application rate of 11.0 g of silver per m².

The improvement in colour reproduction brought about by DIR couplers is based on the fact that the inhibitor released during chromogenic coupling results in a purposeful reduction in further development of the silver and thus also of the image dye. In this manner, the silver halide is not optimally utilised and more silver halide must be provided in the film than is required to form the necessary colour density. On the other hand, this increased silver application rate impairs sharpness, which is in particular noticeable at high levels of enlargement, as is for example encountered in panorama format in the APS system. Furthermore, elevated silver application rates are not desirable from an environmental standpoint.

The object underlying the invention is to achieve sufficient sensitivity at a very low silver application rate without colour reproduction being impaired on pictures illuminated with fluorescent light and in particular without there being an observable green cast.

It has now surprisingly been found that establishing certain CIELab values, in particular when using at least two DIR couplers in the green-sensitive package of layers, at a silver application rate of less than 3.2 g of silver/m² (corresponding to 5.0 g of AgNO₃ per m²), brings about an improvement in colour reproduction on illumination with fluorescent light and in particular brings about a reduced green cast.

The present invention accordingly provides a colour photographic recording material having a support, at least two blue-sensitive, yellow coupler-containing silver halide emulsion layers of differing photographic sensitivity, at least two green-sensitive, magenta coupler-containing silver halide emulsion layers of differing photographic sensitivity and at least two red-sensitive, cyan coupler-containing silver halide emulsion layers of differing photographic sensitivity, characterised in that the silver application rate is less than 3.2 g of silver per m², camera sensitivity is at least ISO 100 (International Organization for Standardization, doubling the ISO value indicates a doubling of film sensitivity) and wherein, when an exposure is made of a grey card of density 0.6 with fluorescent light of light colour 21, the recording material gives rise to a hue on the print which, in CIELab values (Commission International de 1'Éclairage, 1976; CIELab coordinates result in linear, equidistant spacing of the colours when three independent variables are used based on the colour pairs black-white, red-green, yellow-blue), meets the conditions a>0 and 0<b<30, if the photograph exposed with daylight is at a=b=0 with the same print filter pack. In addition to being stated in ISO values, sensitivity is also frequently stated in DIN values with ISO 100 being, as is known, equivalent to DIN 21, which is stated for example for colour films as ISO 100/21°.

For the purposes of the present invention, daylight is taken to mean a continuous light spectrum with a colour temperature of 5500 K, the light possibly being, for example, sunlight or light from an incandescent lamp in conjunction with conversion filters.

For the purposes of the present invention, fluorescent light is taken to mean both that from conventional long fluorescent lamps and that from compact fluorescent lamps from various manufacturers, for example from Philips and Osram. The manufacturers state the light colour of such fluorescent lamps both as number codes and as corresponding descriptions, with light colour 21 also being designated, depending on the manufacturer, as light colour 840 (international ID no.), as “neutral white” or as “cool white

”.

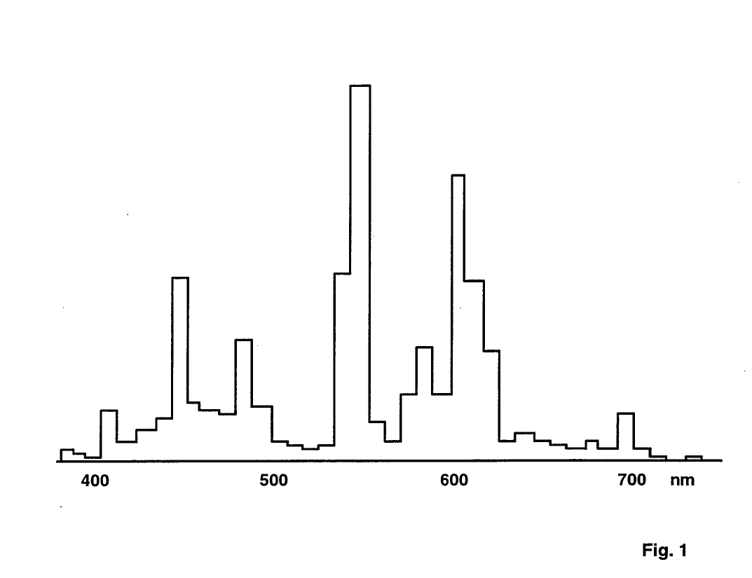

This light, as shown in FIG. 1, is composed of several emission lines and has a colour temperature of 4000 K.

It has surprisingly been found that the adjustment according to the invention of the recording material when this illumination is used gives rise to a particularly versatile, multi-purpose material which exhibits no green cast whether under daylight conditions or in various kinds of fluorescent light.

A print should be taken to mean a reflection print which is obtained from the recording material according to the invention by means of a printing process. In a preferred embodiment of the invention, the recording material comprises a colour negative film which, once exposed and processed, gives rise to a colour negative, which is then exposed with a photographic printer onto colour negative paper, from which the print is obtained after processing.

The set of printer settings used for a particular film to obtain neutral prints is known as the print filter pack.

The type and number of DIR couplers in the green-sensitive package of layers is of particular significance as their properties coupling speed, diffusibility and inhibition interact with the silver halide emulsion properties spectral sensitivity, development time behaviour and susceptibility to inhibition to determine their impact on colour reproduction.

The CIELab values may furthermore be established by known measures, such as for example by adjusting the spectral sensitivity distribution and absorption spectra of the image dyes of the colour photographic recording material.

Despite elevated sensitivity and excellent colour reproduction on illumination with fluorescent light, a material with a particularly low silver content is, however, obtained if the material contains at least two different DIR couplers in the green-sensitive colour package or in a reactive relationship therewith.

For the purposes of the present invention, colour package is taken to mean a unit of at least two silver halide emulsion layers with different sensitivity which are sensitised to the same range of the visible spectrum (blue, green or red). The spectral sensitivity distribution within the colour package may vary from layer to layer within the particular range of the spectrum, but the spectral sensitivity distribution within the colour package is preferably as uniform as possible.

For the purposes of the present invention, a colour package may also contain 3, 4 or more silver halide emulsion layers of differing sensitivity and, in particular for the red- and green-sensitive colour package, it is preferred if the package in each case has at least three silver halide emulsion layers of differing sensitivity.

The DIR couplers according to the invention are preferably used directly in a silver halide emulsion layer, but may also be used in a reactive relationship therewith. The latter phrase means that the DIR couplers are used in a layer which does not itself contain any silver halide emulsion, but the developer oxidation product (DOP) released during development of the recording material according to the invention is nevertheless able to reach the layer with the DIR coupler. Such layers in particular comprise interlayers directly adjacent to a silver halide emulsion, said interlayers preferably containing no DOP scavenger.

For the purposes of the invention, whenever it is stated that the DIR couplers according to the invention are contained in the silver halide emulsion layer or colour package, the embodiment in which they are in a reactive relationship with the silver halide emulsion layer or colour package is always also understood.

In one particularly advantageous embodiment of the invention, the green-sensitive silver halide emulsion layer with the highest sensitivity contains at least two different DIR couplers.

The total quantity of the DIR couplers blended according to the invention is preferably 0.2 to 100 mg/m² and particularly preferably 5-50 mg/m².

Each of the at least two DIR couplers according to the invention is used in the blend in an amount of at last 10 mol %, preferably of at least 25 mol % and particularly preferably of at least 35 mol %.

In a preferred embodiment of the invention, the DIR couplers are selected from among compounds of the structures Ia, Ib or II: 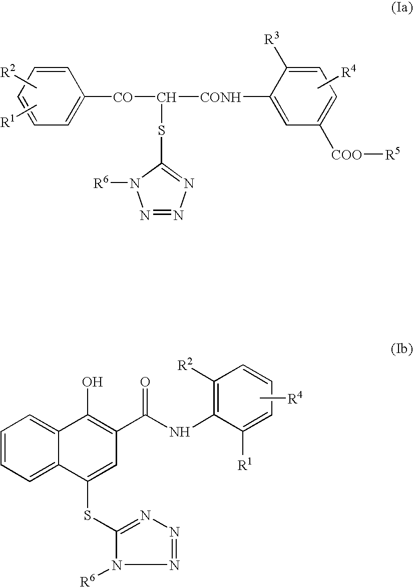
in which
R¹ means alkyl, alkoxy,
R² means a hydrogen atom or a substituent,
R³ means alkyl, aryl, aryloxy or a halogen atom,
R⁴ means a hydrogen atom or a substituent,
R⁵ means alkyl, alkylaryl, alkylcarbonyl or alkoxycarbonylalkyl and
R⁶ means aryl, alkyl; 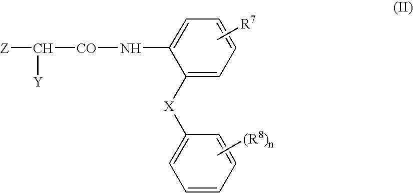
   in which
R⁷ means H, Cl, —CF₃, alkoxy, sulfamoyl;
R⁸ means H, Cl, alkyl, cycloalkyl, alkoxy, alkoxycarbonyl, carbamoyl;
n means 0, 1 or 2;
X means O or S;
Y means a residue with a silver halide development inhibition function which is releasable on colour development;
Z means benzoyl, pivaloyl, carbamoyl or a quinazolin-4-on-2-yl residue.

For the purposes of the present invention, alkyl residues may be linear, branched or cyclic.

Alkyl, aryl and heteroaryl groups may, for example, be substituted, wherein substituents which may be considered are for example, alkyl, alkenyl, alkynyl, alkylene, aryl, heterocyclyl, hydroxy, carboxy, halogen, alkoxy, aryloxy, heterocyclyloxy, alkylthio, arylthio, heterocyclylthio, alkylseleno, arylseleno, heterocyclylseleno, acyl, acyloxy, acylamino, cyano, nitro, amino, thiono or mercapto groups, and wherein heterocyclyl denotes a saturated, unsaturated or aromatic heterocycle and acyl denotes the residue of an aliphatic, olefinic or aromatic carboxylic, carbamic, carbonic, sulfonic, amidosulfonic, phosphoric, phosphonic, phosphorous, phosphinic or sulfinic acid.

The stated substituents may also be considered for R² and R⁴ in formulae (Ia) and (Ib).

R¹ is preferably alkoxy; R² and R⁴ are preferably hydrogen atoms; R³ is preferably a chlorine atom; R⁶ is preferably an optionally substituted phenyl residue.

In a preferred embodiment of the invention, a DIR coupler of the formula (II) and a DIR coupler of the formula (Ia) or a DIR coupler of the formula (II) and a DIR coupler of the formula (Ib) are used according to the invention in the green-sensitive colour package and in particular in the most highly sensitive silver halide emulsion layer, wherein it is particularly advantageous to use a DIR coupler of the formula (II) together with a DIR coupler of the formula (Ia), and it is furthermore particularly preferred additionally to use therein at least a third DIR coupler, which is in particular of the formulae (Ia), (Ib) or (II).

Suitable DIR couplers of the formula (I) according to the invention are:

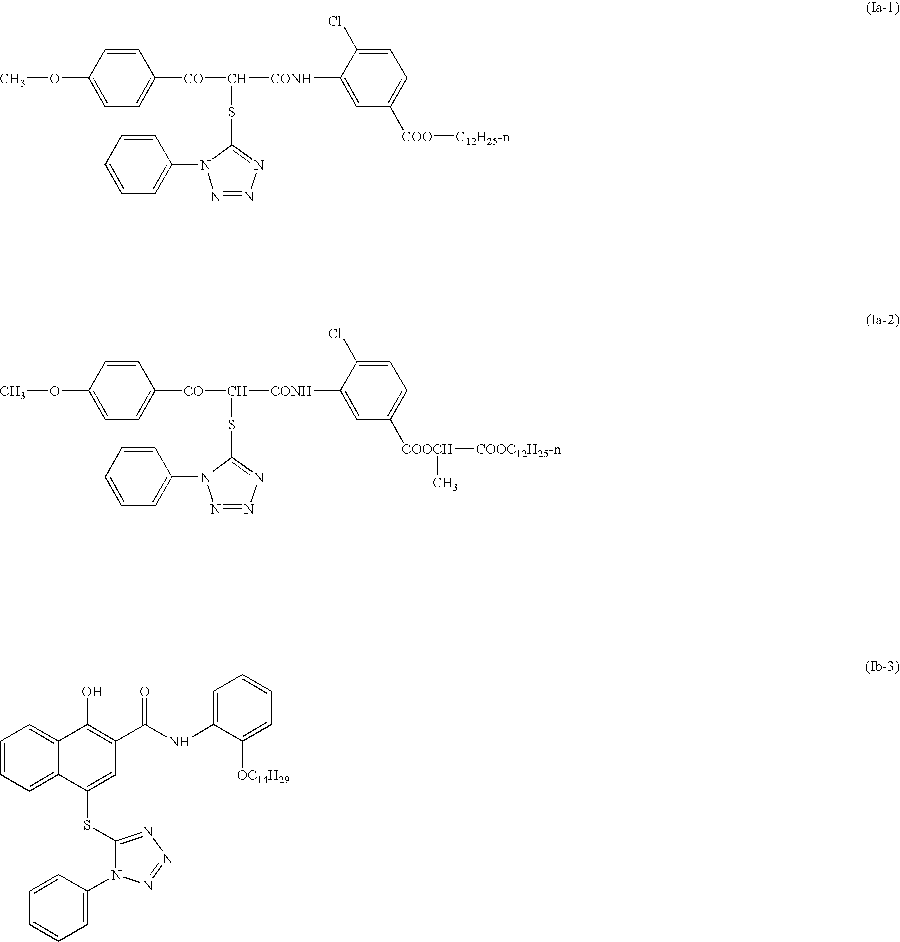

An alkoxy residue represented by R⁷ in formula II may, for example, contain up to 16 C atoms. A sulfamoyl residue represented by R⁷ may be mono- or disubstituted, for example with alkyl, cycloalkyl, aralkyl or aryl; two such substituents may also form a 5- or 6-membered ring together with the nitrogen atom.

An alkyl residue represented by R⁸ in formula II contains, for example, 1-10 C atoms. An alkoxy residue represented by R⁸ contains, for example, up to 16 C atoms. An alkoxycarbonyl residue represented by R⁸ contains, for example, up to 17 C atoms. The same applies to a carbamoyl residue represented by R⁸ as applies to the sulfamoyl residue defined under R⁷

In formula II, a cycloalkyl residue represented by R⁸ or contained in R⁷ or R⁸ is preferably cyclohexyl.

A benzoyl residue represented by Z in formula II may be substituted, for example with alkoxy, preferably in para position. A carbamoyl residue represented by Z in formula II is preferably derived from phenylcarbamic acid, in which the phenyl ring may be substituted, for example with Cl, alkoxycarbonyl and/or a group 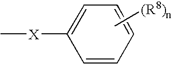
in which X, R⁸ and n have the meaning already stated.

A quinazolin-4-on-2-yl residue represented by Z in formula II may be substituted, for example with Cl or acylamino.

The residue with a silver halide development inhibition function represented by Y in formula II is of the formula
-(TIME)ₙ-INH.

In this formula, INH is a silver halide development inhibitor, n=0 or 1, and the linking member represented by TIME is a group which, after elimination from the coupler's coupling site when the coupler couples with the silver halide developer oxidation product, is capable of releasing the inhibitor attached thereto in a subsequent reaction. The TIME group is also known as a time control member because, in the presence of such a group, the inhibitor attached thereto is in many cases released in delayed manner and may become active. Known time control members are for example an 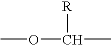
group, wherein the O atom is attached to the coupling site of the coupler and the C atom is attached to an N atom of an inhibitor (for example DE-A-27 03 145), a group which, after elimination from the coupler, is subject to an intramolecular nucleophilic displacement reaction, so releasing the inhibitor (for example DE-A-28 55 697), a group in which, after elimination from the coupler, electron transfer may proceed along a conjugated system, so releasing the inhibitor (for example DE-A-31 05 026) or an 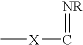
group, in which X (for example —O—) is attached to the coupling site of the coupler and the C atom is attached to an atom of the inhibitor and in which R for example denotes aryl (for example EP-A-0 127 063).

The TIME group may be present or also (where n=0) be entirely absent.

DIR couplers of the formula II, in which Z denotes a quinazolin-4-on-2-yl residue, are preferred and, of these, those in which R⁸ is an o-cyclohexyl residue are in turn preferred.

Preferably used silver halide development inhibitors (Y or INH) are those from the 1,2,3-triazole or 1,2,4-triazole series.

Suitable DIR couplers of the formula (II) according to the invention are: 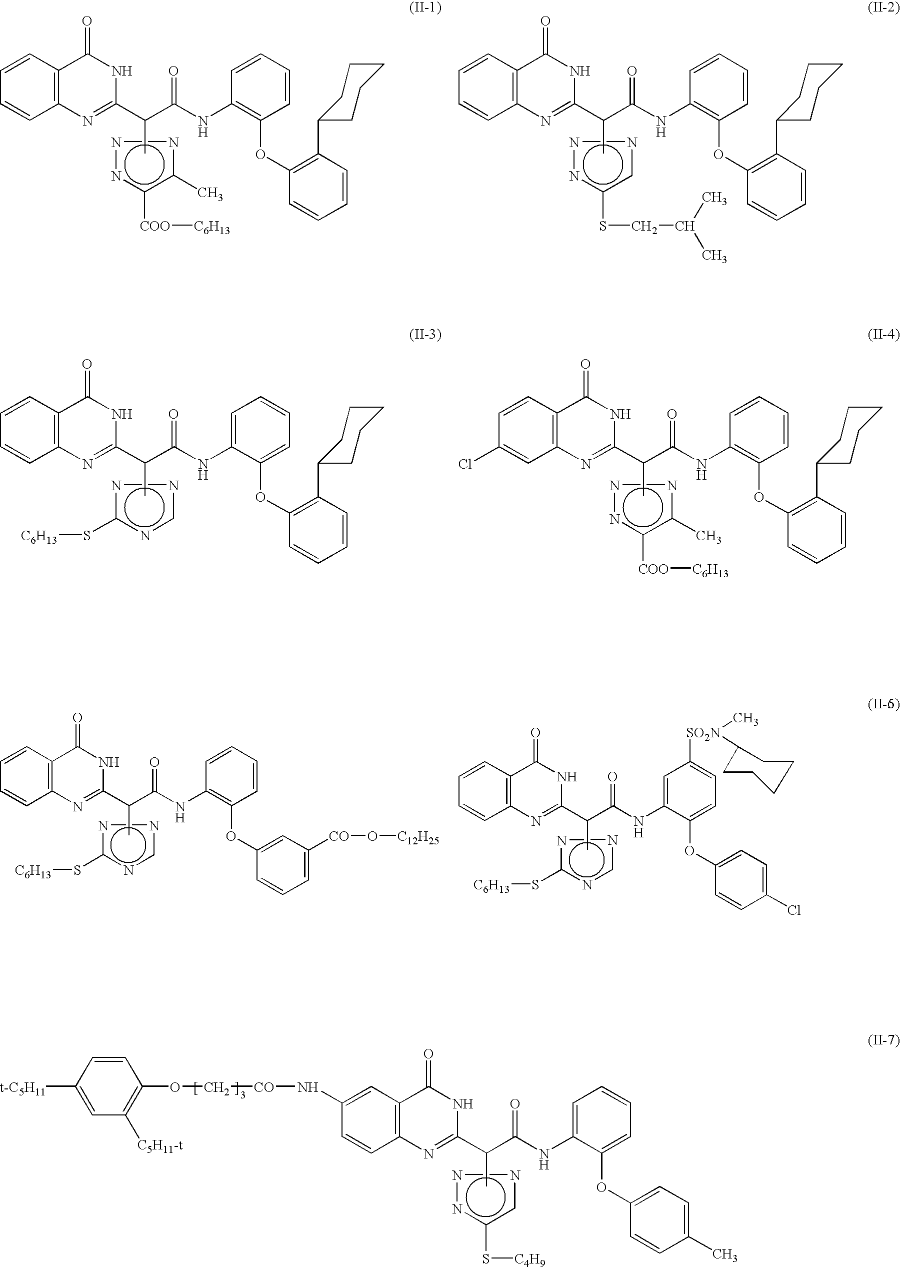 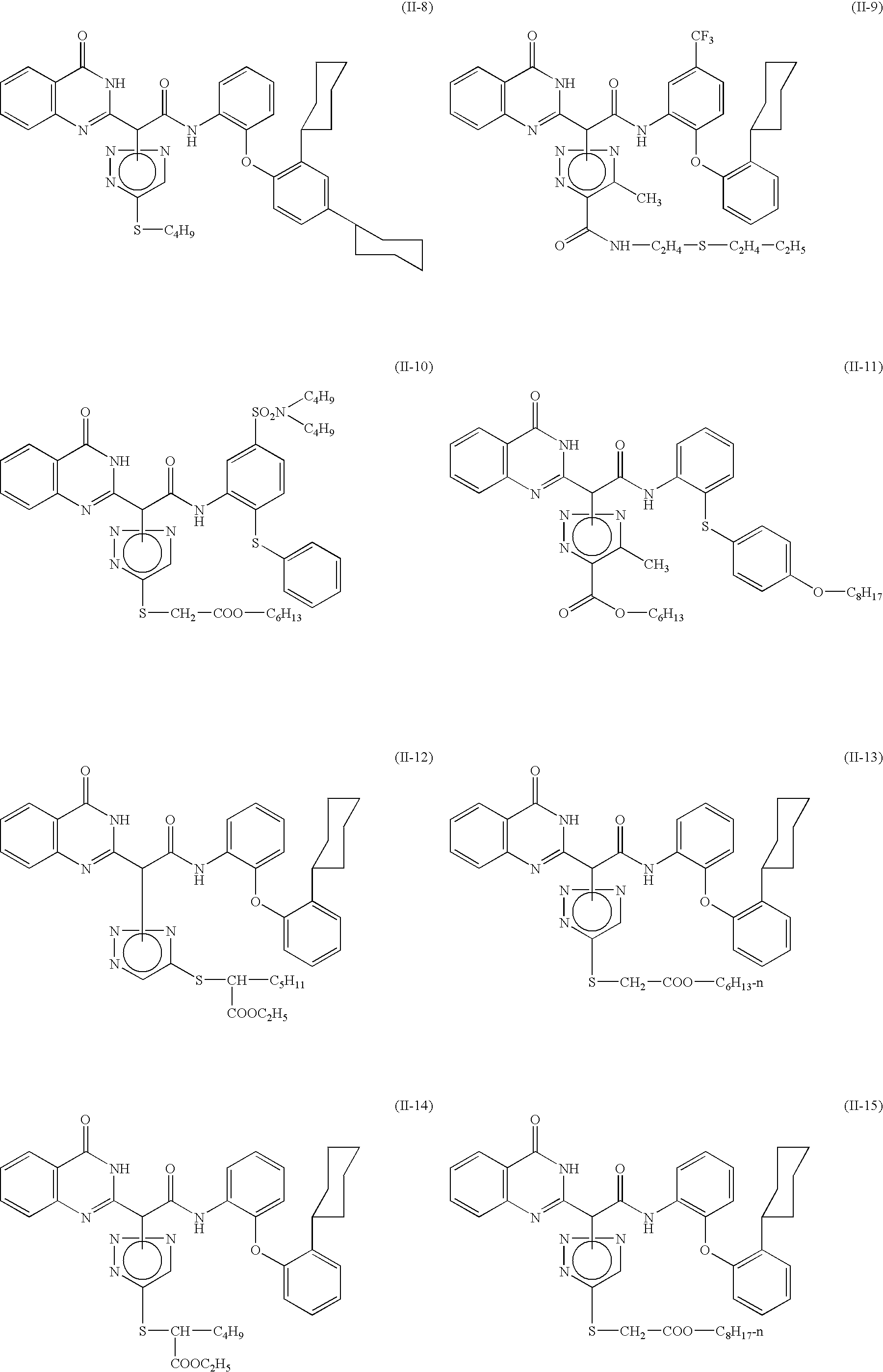
DIR couplers of the formulea (Ia-1), (Ib-3), (II-13) and (II-15) are particularly perferred.

In a preferred embodiment of the invention, the camera sensitivity of the recording material is at least ISO 200 and particularly preferably at least ISO 400.

The photographic materials consist of a support, onto which at least one photosensitive silver halide emulsion layer is applied. Suitable supports are in particular thin films and sheets. A review of support materials and auxiliary layers applied to the front and reverse sides thereof is given in Research Disclosure 37254, part 1 (1995), page 285 and in Research Disclosure 38957, part XV (1996), page 627.

The colour photographic materials conventionally contain at least one red-sensitive, one green-sensitive and one blue-sensitive silver halide emulsion layer, optionally together with interlayers and protective layers.

Depending upon the type of photographic material, these layers may be differently arranged. This is demonstrated for the most important products:

Colour photographic films such as colour negative films have on the support, in the stated sequence, 2 or 3 red-sensitive, cyan-coupling silver halide emulsion layers, 2 or 3 green-sensitive, magenta-coupling silver halide emulsion layers and 2 or 3 blue-sensitive, yellow-coupling silver halide emulsion layers. The layers of identical spectral sensitivity differ with regard to their photographic sensitivity, wherein the less sensitive sublayers are generally arranged closer to the support than the more highly sensitive sublayers.

A yellow filter layer is conventionally located between the green-sensitive and blue-sensitive layers which prevents blue light from penetrating into the underlying layers.

Possible options for different layer arrangements and the effects thereof on photographic properties are described in J. Inf. Rec. Mats., 1994, volume 22, pages 183-193 and in Research Disclosure 38957, part XI (1996), page 624.

The number and arrangement of the photosensitive layers may be varied in order to achieve specific results. For example, all high sensitivity layers may be grouped together in one package of layers and all low sensitivity layers may be grouped together in another package of layers in order to increase sensitivity (DE-25 30 645).

The substantial constituents of the photographic emulsion layers are binder, silver halide grains and colour couplers.

Details of suitable binders may be found in Research Disclosure 37254, part 2 (1995), page 286 and in Research Disclosure 38957, part II.A (1996), page 598.

Details of suitable silver halide emulsions, the production, ripening, stabilisation and spectral sensitisation thereof, including suitable spectral sensitisers, may be found in Research Disclosure 37254, part 3 (1995), page 286, in Research Disclosure 37038, part XV (1995), page 89 and in Research Disclosure 38957, part V.A (1996), page 603.

Photographic materials with camera sensitivity conventionally contain silver bromide-iodide emulsions, which may optionally contain small proportions of silver chloride. Photographic print materials contain either silver chloride-bromide emulsions containing up to 80 mol % of AgBr or silver chloride-bromide emulsions containing above 95 mol % of AgCl.

Details of colour couplers may be found in Research Disclosure 37254, part 4 (1995), page 288, in Research Disclosure 37038, part II (1995), page 80 and in Research Disclosure 38957, part X.B (1996), page 616. The maximum absorption of the dyes formed from the couplers and the colour developer oxidation product is preferably within the following ranges: yellow coupler 430 to 460 nm, magenta coupler 540 to 560 nm, cyan coupler 630 to 700 nm.

In order to improve sensitivity, grain, sharpness and colour separation in colour photographic films, compounds are frequently used which, on reaction with the developer oxidation product, release photographically active compounds, for example DIR couplers which eliminate a development inhibitor.

Details relating to such compounds, in particular couplers, may be found in Research Disclosure 37254, part 5 (1995), page 290, in Research Disclosure 37038, part XIV (1995), page 86 and in Research Disclosure 38957, part X.C (1996), page 618.

Colour couplers, which are usually hydrophobic, as well as other hydrophobic constituents of the layers, are conventionally dissolved or dispersed in high-boiling organic solvents. These solutions or dispersions are then emulsified into an aqueous binder solution (conventionally a gelatine solution) and, once the layers have dried, are present as fine droplets (0.05 to 0.8 μm in diameter) in the layers.

Suitable high-boiling organic solvents, methods for the introduction thereof into the layers of a photographic material and further methods for introducing chemical compounds into photographic layers may be found in Research Disclosure 37254, part 6 (1995), page 292.

The non-photosensitive interlayers generally arranged between layers of different spectral sensitivity may contain agents which prevent an undesirable diffusion of developer oxidation products from one photosensitive layer into another photosensitive layer with a different spectral sensitisation.

Suitable compounds (white couplers, scavengers or DOP scavengers) may be found in Research Disclosure 37254, part 7 (1995), page 292, in Research Disclosure 37038, part III (1995), page 84 and in Research Disclosure 38957, part X.D (1996), pages 621 et seq.

The photographic material may also contain UV light absorbing compounds, optical brighteners, spacers, filter dyes, formalin scavengers, light stabilisers, antioxidants, Dₘᵢₙ dyes, plasticisers (latices), biocides and additives to improve coupler and dye stability, to reduce colour fogging and to reduce yellowing, and others. Suitable compounds may be found in Research Disclosure 37254, part 8 (1995), page 292, in Research Disclosure 37038, parts IV, V, VI, VII, X, XI and XIII (1995), pages 84 et seq. and in Research Disclosure 38957, parts VI, VII, IX and X (1996), pages 607 and 610 et seq.

The layers of colour photographic materials are conventionally hardened, i.e. the binder used, preferably gelatine, is crosslinked by appropriate chemical methods.

Suitable hardener substances may be found in Research Disclosure 37254, part 9 (1995), page 294, in Research Disclosure 37038, part XII (1995), page 86 and in Research Disclosure 38957, part II.B (1996), page 599.

Once exposed with an image, colour photographic materials are processed using different processes depending upon their nature. Details relating to processing methods and the necessary chemicals are disclosed in Research Disclosure 37254, part 10 (1995), page 294, in Research Disclosure 37038, parts XVI to XXm (1995), pages 95 et seq. and in Research Disclosure 38957, parts XVIII, XIX and XX (1996), pages 630 et seq. together with example materials.

### EXAMPLE

A colour photographic recording material for colour negative development (layer structure 1A) was produced by applying the following layers in the stated sequence onto a transparent layer support of cellulose triacetate. Quantities are stated in each case per 1 m². The silver halide application rate is stated as the corresponding quantities of Ag; the silver halides are stabilised with 0.5 g of 4-hydroxy-6-methyl-1,3,3a, 7-tetraazaindene per mol of AgNO3.

1st layer (anti-halo layer)

| | | |
|---|---|---|
| 0.16 | g | of black colloidal silver |
| 1.2 | g | of gelatine |
| 0.15 | g | of DOP scavenger EF-1 |
| 0.2 | g | of UV absorber UV-1 |
| 0.2 | g | of tricresyl phosphate (TCP) |

2nd layer (low-sensitivity red-sensitive layer)

| | | |
|---|---|---|
| 0.48 | g | of Ag of a spectrally red-sensitised Ag(Br,I) emulsion with |
| | | 5 mol % iodide, average grain diameter 0.35 μm |
| 1.4 | g | of gelatine |
| 0.62 | g | of colourless coupler C-1 |
| 0.02 | g | of DIR coupler D-1 |
| 0.09 | g | of coloured coupler RC-1 |
| 0.015 | g | of coloured coupler YC-1 |
| 0.75 | g | of TCP |

3rd layer (medium-sensitivity red-sensitive layer)

| | | |
|---|---|---|
| 0.48 | g | of Ag of a spectrally red-sensitised Ag(Br,I) emulsion, |
| | | 4.5 mol % iodide, average grain diameter 0.47 μm |
| 0.7 | g | of gelatine |
| 0.16 | g | of colourless coupler C-1 |
| 0.06 | g | of coloured coupler RC-1 |
| 0.015 | g | of coloured coupler YC-1 |
| 0.01 | g | of DIR coupler D-1 |
| 0.17 | g | of TCP |

4th layer (high-sensitivity red-sensitive layer)

| | | |
|---|---|---|
| 0.21 | g | of Ag of a spectrally red-sensitised Ag(Br,I) emulsion, |
| | | 4.5 mol % iodide, average grain diameter 0.55 μm |
| 0.4 | g | of gelatine |
| 0.03 | g | of colourless coupler C-2 |
| 0.005 | g | of DIR coupler D-1 |
| 0.03 | g | of TCP |

5th layer (interlayer)

| | | |
|---|---|---|
| 1.1 | g | of gelatine |
| 0.05 | g | of DOP scavenger EF-1 |
| 0.06 | g | of aurintricarboxylic acid aluminium salt |

6th layer (low-sensitivity green-sensitive layer)

| | | |
|---|---|---|
| 0.50 | g | of Ag of a spectrally green-sensitised Ag(Br,I) emulsion, |
| | | 4.2 mol % iodide, average grain diameter 0.40 μm |
| 1.1 | g | of gelatine |
| 0.41 | g | of colourless coupler M-1 |
| 0.005 | g | of DIR coupler D-1 |
| 0.14 | g | of coloured coupler YM-1 |
| 0.55 | g | of TCP |

7th layer (high-sensitivity green-sensitive layer)

| | | |
|---|---|---|
| 0.55 | g | of Ag of a spectrally green-sensitised Ag(Br,I)-emulsion, |
| | | 4.5 mol % iodide, average grain diameter 0.50 μm |
| 1.0 | g | of gelatine |
| 0.09 | g | of colourless coupler M-2 |
| 0.04 | g | of coloured coupler YM-2 |
| 0.13 | g | of TCP |
| 0.008 | g | of DIR coupler D-1 |

8th layer (yellow filter layer)

| | | |
|---|---|---|
| 0.06 | g | of yellow dye GF-1 |
| 1.3 | g | of gelatine |
| 0.02 | g | of coloured coupler YM-2 |
| 0.04 | g | of DOP scavenger EF-1 |
| 0.06 | g | of TCP |

9th layer (low-sensitivity blue-sensitive layer)

| | | |
|---|---|---|
| 0.31 | g | of Ag of a spectrally blue-sensitised Ag(Br,I) emulsion, |
| | | 6.0 mol % iodide, average grain diameter 0.50 μm |
| 3.2 | g | of gelatine |
| 1.1 | g | of colourless coupler Y-1 |
| 0.05 | g | of DIR coupler D-1 |
| 1.1 | g | of TCP |

10th layer (high-sensitivity blue-sensitive layer)

| | | |
|---|---|---|
| 0.38 | g | of Ag of a spectrally blue-sensitised Ag(Br,I) emulsion, |
| | | 6.5 mol % iodide, average grain diameter 0.70 μm |
| 0.6 | g | of gelatine |
| 0.15 | g | of colourless coupler Y-1 |
| 0.01 | g | of DIR coupler D-1 |
| 0.16 | g | of TCP |

11th layer (micrate layer)

| | | |
|---|---|---|
| 0.04 | g | of Ag of a micrate Ag(Br,I) emulsion, average grain |
| | | diameter 0.06 μm, 0.5 mol % iodide |
| 1 | g | of gelatine |
| 0.3 | g | of UV absorber UV-2 |
| 0.3 | g | of TCP |

12th layer (protective and hardening layer)

| | | |
|---|---|---|
| 0.25 | g | of gelatine |
| 0.75 | g | of hardener H-1 |
| | | such that, once hardened, the overall layer structure |
| | | had a swelling factor of ≦3.2. |

Substances used in Example 1:

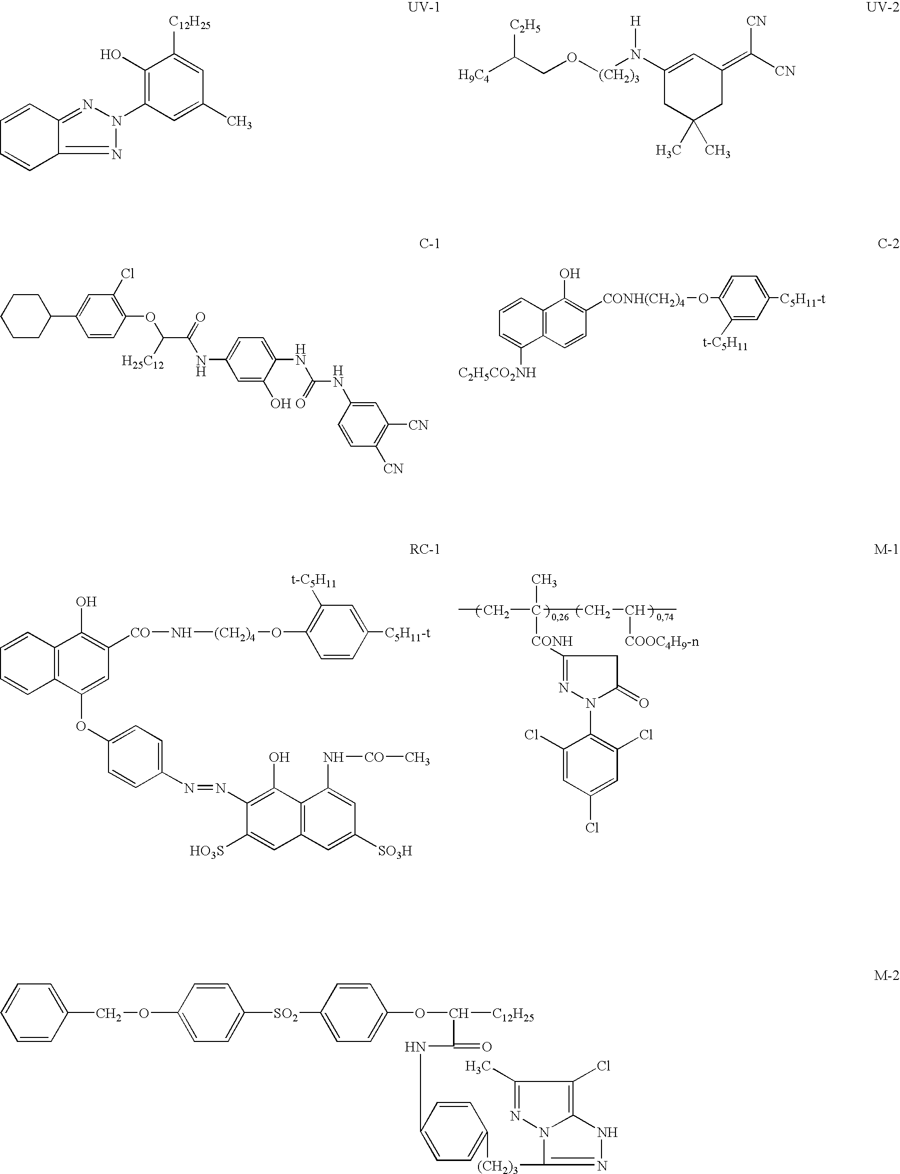

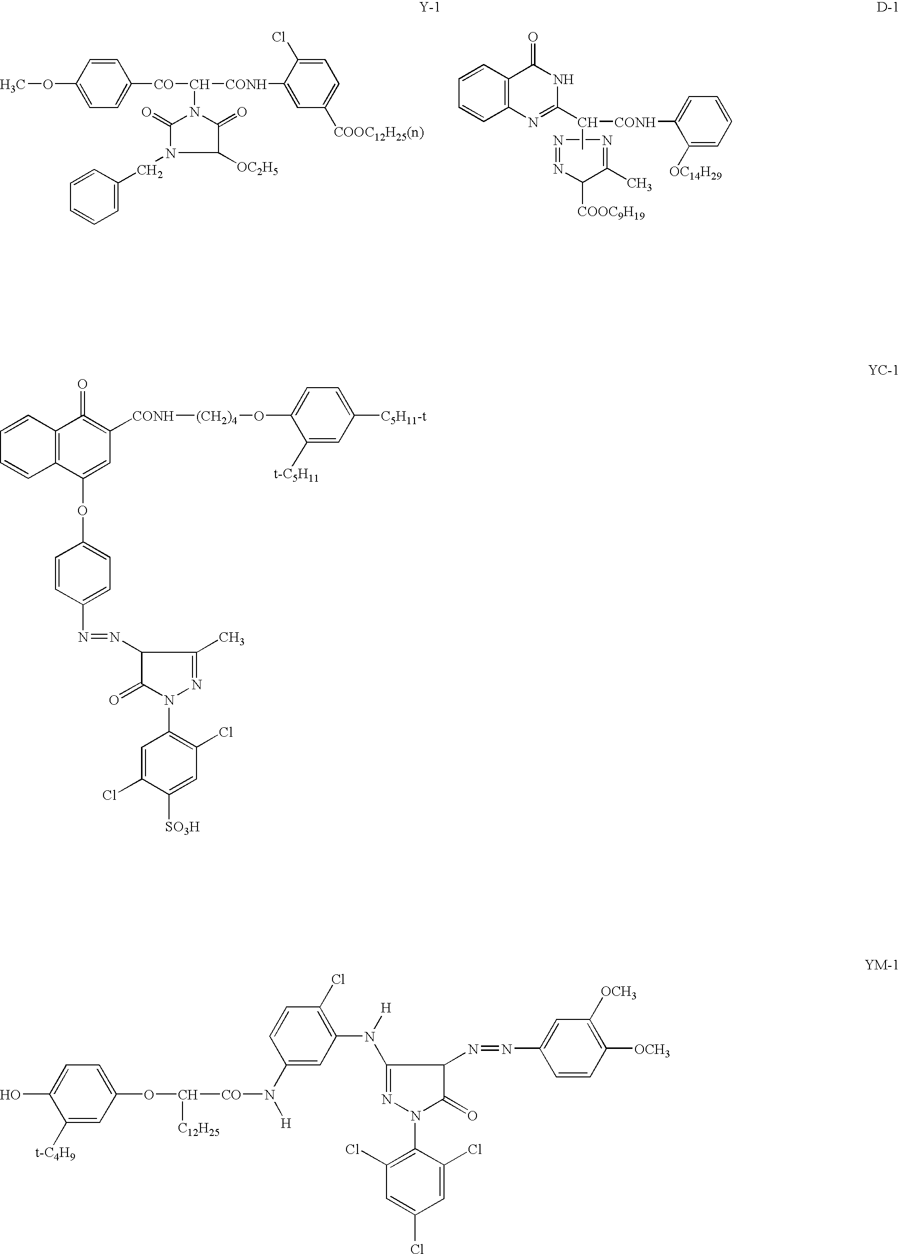

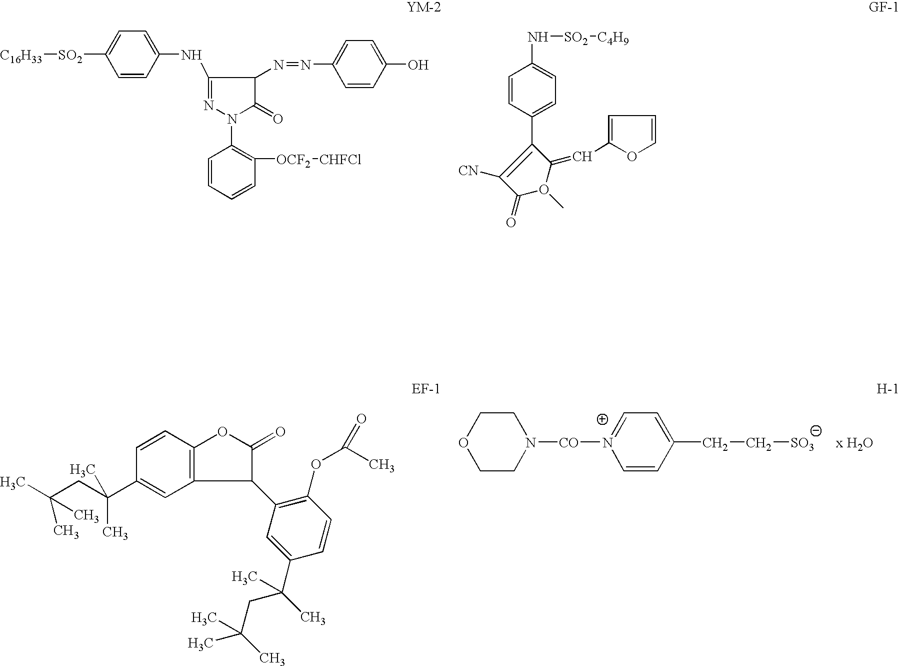

After exposure with a grey wedge, the material is developed in accordance with “The British Journal of Photography”, 1974, pages 597 and 598.

Layer structures 1A-1F differ in the 7th layer, which contains the following silver application rates and DIR couplers:

TABLE 1

| | Silver | | | | | |
|---|---|---|---|---|---|---|
| | application rate | DIR coupler [g/m²] | | | | |
| Layer | 7th layer | 7th layer | | | | |
| structure | [g Ag/m²] | II-13 | Ia-1 | II-15 | Ib-3 | |
| 1A | 0.55 | 0.008 | 0 | 0 | 0 | Comparison |
| 1B | 0.55 | 0 | 0.020 | 0 | 0 | Comparison |
| 1C | 0.55 | 0 | 0 | 0.015 | 0 | Comparison |
| 1D | 0.70 | 0.009 | 0 | 0 | 0 | Comparison |
| 1E | 0.70 | 0.008 | 0.005 | 0 | 0 | Comparison |
| 1F | 0.55 | 0.004 | 0.013 | 0 | 0 | Invention |
| 1G | 0.55 | 0.004 | 0.013 | 0.010 | 0 | Invention |
| 1H | 0.55 | 0.004 | 0.013 | 0 | 0.012 | Invention |

Layer structure 2a contains a blend of the DIR couplers in the 3rd layer (red-sensitive sub-package) instead of D-1:

| | Silver | | | | | |
|---|---|---|---|---|---|---|
| | application rate | DIR coupler [g/m²] | | | | |
| Layer | 3rd layer | 3rd layer | | | | |
| structure | [g Ag/m²] | II-13 | Ia-1 | II-15 | Ib-3 | |
| 2A | 0.48 | 0.002 | 0.007 | 0.05 | 0 | Comparison |

The photographic results are shown in tables 2 and 3. The shift in hue is measured by photographing a grey card of density 0.6 under daylight and in fluorescent light of light colour 21. Both negatives are printed with the same filter pack. The value stated is the difference in CIELab units between the two types of exposure. The yes/no evaluation of colour cast is based on a visual comparison of the grey cards and is relative to the print exposed with fluorescent light.

TABLE 2

| | Sensitivity | Shift in hue | | Green | |
|---|---|---|---|---|---|
| Layer | Green | CIELab parameter | | colour | |
| structure | [ISO] | a | b | cast | |
| 1A | 100 | −3 | 28 | yes | Comparison |
| 1B | 79 | 0 | 31 | no | Comparison |
| 1C | 102 | −6 | 30 | yes | Comparison |
| 1D | 106 | −8 | 28 | yes | Comparison |
| 1E | 112 | 2 | 29 | no | Comparison |
| 1F | 115 | 7 | 29 | no | Invention |
| 1G | 103 | 5 | 28 | no | Invention |
| 1H | 107 | 6 | 27 | no | Invention |

TABLE 3

| | | Shift in hue | | Green | |
|---|---|---|---|---|---|
| Layer | Sensitivity | CIELab parameter | | colour | |
| structure | Red [ISO] | a | b | cast | |
| 1A | 100 | −3 | 28 | yes | Comparison |
| 2A | 98 | −4 | 27 | yes | Comparison |

As can be seen, in the materials according to the invention, owing to the combination of at least two of the DIR couplers according to the invention in a green-sensitive sublayer, an improvement in colour reproduction under fluorescent light is obtained in that a green colour cast is avoided while maintaining elevated sensitivity.

1. a colour photographic recording material having a support, at least two blue-sensitive, yellow coupler-containing silver halide emulsion layers of differing photographic sensitivity, at least two green-sensitive, magenta coupler-containing silver halide emulsion layers of differing photographic sensitivity and at least two red-sensitive, cyan coupler-containing silver halide emulsion layers of differing photographic sensitivity, characterised in that the silver application rate is less than 3.2 g of silver per m², camera sensitivity is at least ISO 100 and wherein, when an exposure is made of a grey card of density 0.6 with fluorescent light of light colour 21, the recording material gives rise to a hue on the print which, in CIELab values, meets the conditions a>0 and 0<b<30, if the photograph exposed with daylight is at a=b=0 with the same print filter pack.

2. A colour photographic recording material according to claim 1, characterised in that the material contains at least two different DIR couplers in the green-sensitive colour package or in a reactive relationship therewith.

3. A colour photographic recording material according to claim 2, characterised in that the green-sensitive silver halide emulsion layer with the highest sensitivity contains at least two different DIR couplers.

4. A colour photographic recording material according to claim 2, characterised in that the at least two different DIR couplers are selected from among the formulae (Ia-1), (II-13), (II-15) and (Ib-3)

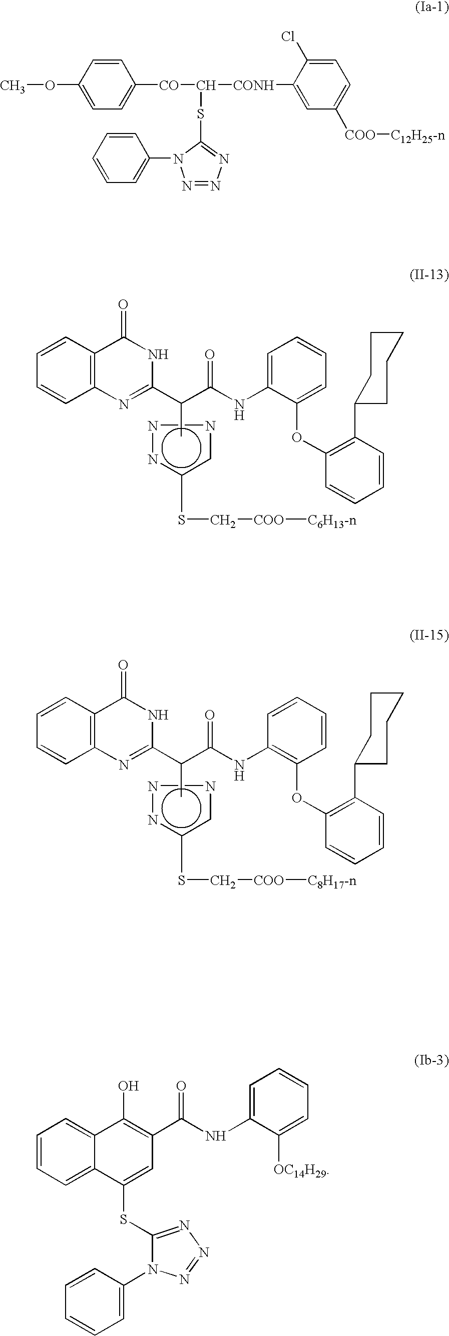

5. A colour photographic recording material according to claim 2, characterised in that the quantity of DIR coupler used amounts in total to 5-100 mg/m².

6. A colour photographic recording material according to claim 2, wherein the quantity of DIR coupler used amounts in total to 5-50 mg/m².

7. A colour photographic recording material according to claim 2, wherein at least two DIR couplers are used in the blend in an amount of at least 10 mol %.

8. A colour photographic recording material according to claim 2, wherein at least two DIR couplers are used in the blend in an amount of at least 25 mol %.

9. A colour photographic recording material according to claim 2, wherein at least two DIR couplers are used in the blend in an amount of at least 35 mol %.

10. A colour photographic recording material according to claim 2, wherein the DIR couplers are compounds of the structures Ia, Ib or II: 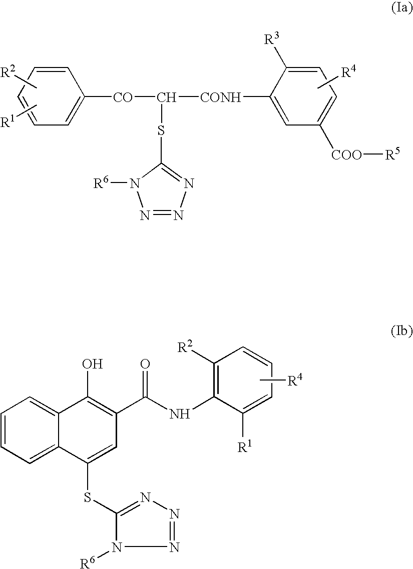
in which
R¹ is alkyl or alkoxy,
R² is a hydrogen atom or a substituent,
R³ is alkyl, aryl, aryloxy or a halogen atom,
R⁴ is a hydrogen atom or a substituent,
R⁵ is alkyl, alkylaryl, alkylcarbonyl or alkoxycarbonylalkyl and
R⁶ is aryl or alkyl; 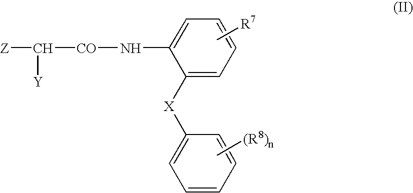
in which
R⁷ is H, Cl, —CF₃, alkoxy or sulfamoyl;
R⁸ is H, Cl, alkyl, cycloalkyl, alkoxy, alkoxycarbonyl or carbamoyl;
n is 0, 1 or 2;
X is O or S;
Y is a residue with a silver halide development inhibition function which is releasable on color development;
Z is benzoyl, pivaloyl, carbamoyl or a quinazolin-4-on-2-yl residue.

11. A colour photographic recording material according to claim 10, wherein R¹ is alkoxy; R² and R⁴ are hydrogen atoms; R³ is a chlorine atom; R⁶ is an optionally substituted phenyl residue.

12. A colour photographic recording material according to claim 10, wherein Z is a quinazolin-4-on-2-yl residue, and R⁸ is an o-cyclohexyl residue.

13. A colour photographic recording material according to claim 1, wherein the camera sensitivity of the recording material is at least ISO 200.

14. A colour photographic recording material according to claim 1, wherein the camera sensitivity of the recording material is at least ISO 400.
